(19) United States
(12) Patent Application Publication
(10) Pub. No.: US 2009/0181354 A1
(43) Pub. Date: Jul. 16, 2009

(54) INTERACTIVE LEARNING

(75) Inventor: Mousumi Dasgupta, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES INC., Temple Terrace, FL (US)

(21) Appl. No.: 12/013,887

(22) Filed: Jan. 14, 2008

(51) Int. Cl. G09B 3/00

(52) U.S. Cl. 434/350

(57) ABSTRACT

A method may include identifying, by a computer, academic class names stored in a database and associated with a student; selecting, by the computer, an assignment from a plurality of assignments based on the identified class names; sending the selected assignment through a network to the student; receiving, through the network, a completed assignment from the student; and adding points, after receiving the completed assignment from the student, to an account associated with the student.

### BACKGROUND INFORMATION

On average, students in the United States spend four hours each day watching television. Even if students were to watch educational television during this time, which they probably would not, the students would still be passively watching—not the ideal educational setting.

### BRIEF DESCRIPTION OF THE DRAWINGS

FIG. 1 shows an exemplary environment in which embodiments described herein may be implemented;

FIG. 2 is a block diagram of exemplary components of a computing module;

FIG. 3 is a block diagram of an exemplary point table;

FIG. 4 is a block diagram of an exemplary user table;

FIG. 5 is a block diagram of an exemplary achievement table;

FIG. 6 is a diagram of a remote control;

FIG. 7 is a flowchart of an exemplary process for creating course profiles and assignments;

FIG. 8 is a flowchart of an exemplary process for testing students;

FIG. 9 is a block diagram of a graphical user interface for displaying an exemplary quiz question;

FIG. 10 is a block diagram of an exemplary environment for an interactive quiz show;

FIG. 11 is a flowchart of an exemplary process for an interactive quiz game show;

FIG. 12 is a block diagram of an exemplary graphical user interface for displaying an interactive quiz show;

FIG. 13 is a block diagram of an exemplary graphical user interface for displaying an exemplary student profile; and

FIG. 14 is a block diagram of an alternative exemplary environment in which systems and methods described herein may be implemented.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Interactive learning may be a better learning environment for students when compared to passive television viewing or other non-learning activities. In one or more embodiments described herein, students may communicate and collaborate with their teachers, peers, and parents in a learning environment.

One or more embodiments disclosed herein may allow for students to be rewarded for completing assignments and/or quizzes. In one embodiment, points may be added to an account associated with a student when the student completes an assignment or quiz. In one embodiment, the points added to the account associated with the student may be dependent upon how well the student does on the assignment or quiz. In one embodiment, points may be awarded to a team of students collaborating together. Students may redeem their points by purchasing merchandise or being allowed to participate in activities, such as playing games.

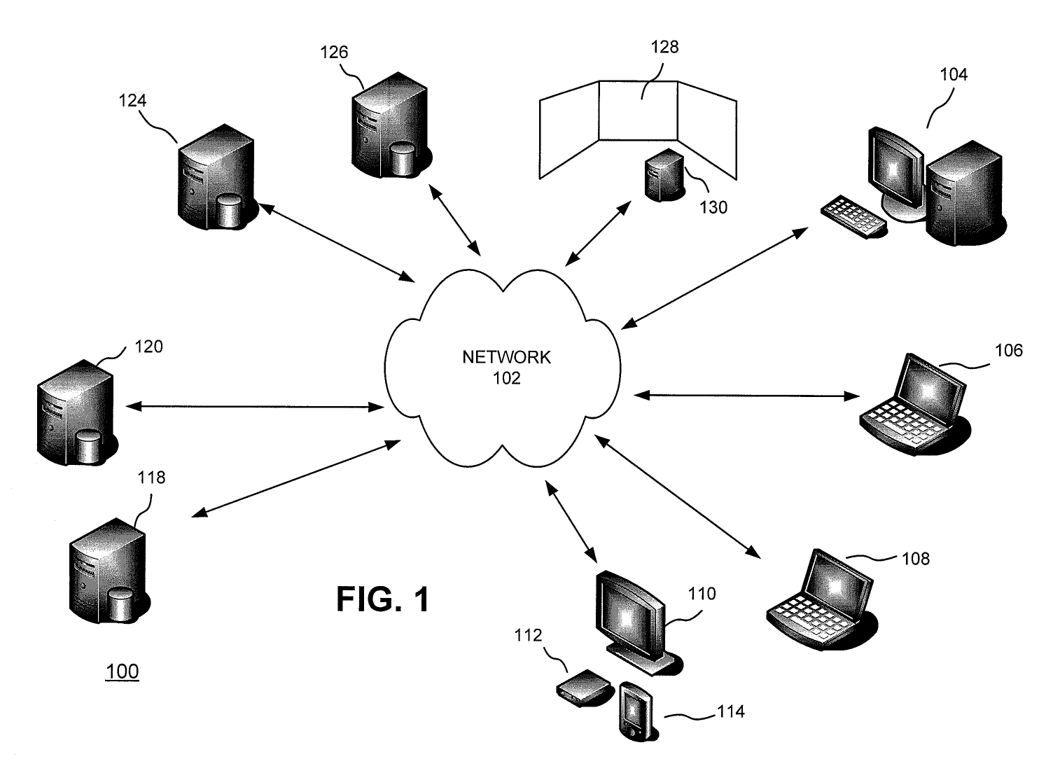

FIG. 1 shows an exemplary interactive educational environment 100 (“environment 100” or “interactive environment 100”) in which embodiments described herein may be implemented. As shown, environment 100 may include a network 102 communicating with a group of devices 104-130. These devices may include, among other things, a classroom computer 104, a student computer 106, a parent computer 108, a television 110 (“TV 110”), a set-top-box 112 (“STB 112”), a remote control 114 (“remote 114”), a course curriculum, course profile, and assignment database 118, an application and web server 120, a profile database 124, a materials database 126, a studio 128, and a studio server 130.

In other embodiments, environment 100 may include more, fewer, or different devices. For example, environment 100 may include printers for printing documents on paper. As another example, environment 100 may include more than one student computer, more than one parent computer, more than one classroom computer, etc. Moreover, one or more devices 104-130 may perform one or more functions of any other device of personal network 100. Furthermore, one or more of devices 104-130 may be remotely located from each other. Although FIG. 1 shows devices 104-130 coupled to network 102, devices 104-130 may also be coupled with each other and/or may be able to communicate directly with each other. For example, parent computer 108 may be directly coupled to student computer 118, without traversing network 102.

Besides the devices shown in FIG. 1, devices coupled to network 102 may include any computational device, including among other things: a camcorder, a personal computer; a telephone, such as a radio telephone; a personal communications system (PCS) terminal that may combine a cellular radiotelephone with data processing, facsimile, and/or data communications capabilities; an electronic note pad; a personal music player (PMP); a personal digital assistant (PDA) that may provide Internet/intranet access, web browser, organizer, calendar, and a global positioning system (GPS).

Network 102 may include the Internet, an ad hoc network, a local area network (LAN), a wide area network (WAN), a metropolitan area network (MAN), a cellular network, a public switched telephone network (PSTN), or any other network or combinations of networks. Network 102 may include a high-speed fiber optic network, such as Verizon's FiOS™ network. A fiber-optic network may provide for a high-speed link from network 102 to devices coupled to network 102, e.g., STB 112, and a high-speed link from devices coupled to network 102, e.g., STB 112, to network 102. In one embodiment, the link from network 102 to devices coupled to network 102, e.g., STB 112, may be symmetric or near symmetric, allowing for data rates to be the same or near the same, e.g., high speed, from network 102 to devices coupled to network 102 and vice versa. Network 102 may include a video signaling and distribution network to distribute the information from a content delivery system.

Classroom computer 104 (“computer 104”) may include one or more computer systems for hosting programs, databases, and/or applications. Computer 104 may include a laptop or any computing device, e.g., a PDA, PMP, mobile phone, etc. Computer 104 may be located in a school classroom and may be accessible by a teacher and/or student, for example. A teacher may use computer 104, for example, to create quizzes, homework assignments, or course materials for students. The teacher may use computer 104 to download educational materials from materials database 126 for incorporation into quizzes, assignments, or course materials. The teacher may use computer 104 to send quizzes, assignments, or other course materials to students (or otherwise make them available to students, such as by posting the materials to assignment database 118 or accessible storage medium). The teacher may use computer 104 to receive completed quizzes or assignments from students. Assignments, quizzes, and other course material, for example, may include Portable Document Format (PDF) documents, word processing documents, video files, audio files, text files, etc. The teacher may use computer 104 to grade student assignments or quizzes and may access student profiles in profile database 124. The teacher may use computer 104 to communicate with students (via email or messaging (e.g., text message and/or instant messaging)) and/or communicate with parents. Computer 104 may be used in the classroom to present course materials to students in the classroom.

Student computer 106 (“computer 106”) may include one or more computer systems for hosting programs, databases, and/or applications. Computer 106 may include a laptop or any computing device, e.g., a PDA, PMP, mobile phone, etc. Computer 106 may be used by a student in the student's home or in the student's classroom, for example. Computer 106 may include a media manager application program for storing, organizing, and playing digital media. For example, the media manager may stream music stored on computer 106 to TV 110. The media manager may send digital photographs stored on student computer 106 for display on TV 110 or parent computer 108. The media manager may create play lists of digital media and slide shows of photographs. The media manager may download digital media content from, for example, television broadcasts, the Internet, and/or a home network.

Computer 106 may include a browser application program for navigating the Internet and/or World-Wide Web (WWW). A student may use student computer 106 to receive assignments in any suitable formate, including PDF documents, word processing documents, video files, music files, text files, etc. A student may use computer 106 to communicate with (via email or messaging) other students, parents, and/or teachers. Computer 106 may be used to watch live classroom sessions. Computer 106 may be used to take interactive quizzes and complete assignments or participate in an online, interactive quiz show.

Parent computer 108 (“computer 108”) may include one or more computer systems for hosting programs, databases, and/or applications. Computer 108 may include a laptop or any computing device, e.g., a PDA, PMP, mobile phone, etc. Using computer 108, the parent may access a student's profile (e.g., a child's profile) stored in profile database 124. Using computer 108, the parent may email or message a student or the student's teacher. Using computer 108, the parent may request help, e.g., academic coaching or tutoring, for a student in need. Using computer 108, the parent may manage a student's account, e.g., configure who can access profile information, etc. Using computer 108, the parent may also view the student's curriculum, course profiles, course assignments, communications, etc. Using computer 108, the parent may view a student's progress as reported by teachers or view developmental graphs, recommended courses, or self help materials that may be downloaded and/or purchased in form of video-on-demand (VOD) content or interactive content.

TV 110 may include a liquid crystal display (LCD), a cathode ray tube (CRT), a plasma display, etc. Television 110 may be associated with one or more speakers that output audio signals, such as stereo or mono audio. Television 110 may be associated with STB 112. STB 112 may include one or more computer systems for hosting programs, databases, and/or applications. STB 112 may receive communications from a cable and/or network service provider and may output video signals for display on TV 110. STB 112 may send communications to a cable and/or network service provider, e.g., requests for content for display. STB 112 may be used to order and receive VOD content from a content provider. TV 110 may be associated with remote 114. Remote 114 may include control keys to navigate menus displayed on TV 110, for example, and to otherwise control functions of TV 110. TV 110 may perform the same functions as student computer 106 and/or parent computer 108.

Course curriculum, course profile, and assignment database 118 (“database 118”) may store course curricula, e.g., topics and subjects that a teacher may be required to teach. Database 118 may also store a teacher's course profile, e.g., a teacher's teaching plan including assignments with material copied from materials database 126 or referred to as being stored in materials database 126. Database 118 may also store assignments and quizzes prepared by the teacher for class.

Application and web server 120 (“server 120”) may include one or more computer systems for hosting programs, databases, and/or applications. Server 120 may run a web server application, such as Apache, to serve web pages when requested. Server 120 may serve pages including information from profile database 124, materials database 126, or database 118. For example, if the parent uses a web browser in computer 108 to access a student's profile, the request may be sent to server 120, which may request the information from profile database 124. Server 120 may then serve the information to computer 108 for viewing by the parent.

Server 120 may allow for messaging between student, teachers, and/or parents. Messaging between students, teachers, and/or parents may include “white boarding,” e.g., the interactive free-hand writing collaboration between students, teachers, and/or parents. Server 120 may allow for the viewing of live classes from a classroom or from studio 128. Server 120 may allow for other forms of collaboration between students, teachers, and parents, including Voice over Internet Protocol (VoIP) or video conferencing, for example. Server 120 may include an application to help a teacher to use classroom computer 104 to develop course profiles or quizzes. Server 120 may automatically score online quizzes taken by students. Server 120 may evaluate student performance, e.g., a student's scores, and may recommend an interactive study course to improve student performance.

Profile database 124 may store profiles associated with students, teams of students, or schools. A student's profile may include quizzes, assignments, quiz scores, assignment scores, the identity of individuals privileged to access the profile, etc. A student's profile may include an indication of the school the student attends. A student profile may include the grade (e.g., scores) the student has achieved in each class and the number of points the student has earned for completing quizzes and assignments. A team's profile may include quizzes, assignments, quiz scores, and assignment scores of teams of students. For example, a chemistry class team may have its own profile. A team's profile may also include the points earned by the team for completing quizzes and assignments. A school's profile may include quizzes, assignments, quiz scores, and assignment scores of schools. A school's profile may also include the points earned by the school for completing quizzes and assignments.

Materials database 126 may include a library of instructional resources. The instructional resources may be categorized and organized and may be searched by, for example, teachers, students, or parents. Videos across numerous topics may be stored in materials database 126 and may simplify difficult topics to increase learning retention. Materials database 126 may include recorded classes, VOD, course profiles, projects, worksheets, quizzes, glossaries, encyclopedias, dictionaries, etc. The teacher may upload course profiles, assignments, and quizzes that the teacher created to materials database 126 for sharing with other teachers.

Studio 128 may include a recording studio (including one or more microphones and/or video cameras), a stage, an amphitheater, etc. Studio 128 may be located in a school or in the offices of a major broadcasting network, for example. Studio 128 may allow for conferences, plays, game shows, television shows, etc. Studio 128 may include studio server 130 that may broadcast events taking place in studio 128.

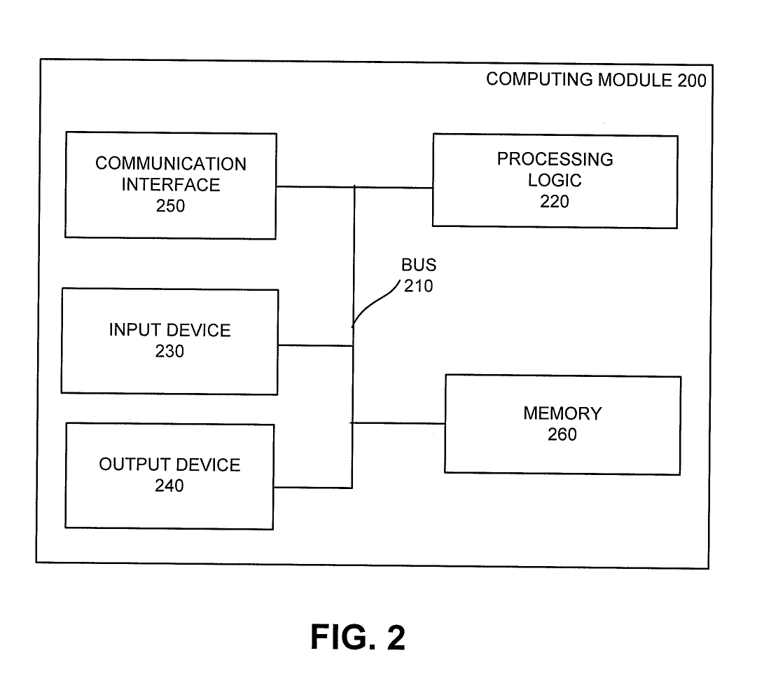

FIG. 2 is a block diagram of exemplary components of a computing module 200 (“module 200”). Any one of devices 104-130 may include one or more computing modules, such as computing module 200. Module 200 may include a bus 210, processing logic 220, an input device 230, an output device 240, a communication interface 250, and a memory 260. Module 200 may include other components (not shown) that aid in receiving, transmitting, and/or processing data. Moreover, other configurations of components in device 200 are possible. Further, one or more components of module 200 may be remotely located.

Bus 210 may include a path that permits communication among the components of module 200. Processing logic 220 may include any type of processor or microprocessor (or groups of processors or microprocessors) that interprets and executes instructions. In other embodiments, processing logic 220 may include an application-specific integrated circuit (ASIC), a field-programmable gate array (FPGA), or the like.

Input device 230 may include a device that permits a user to input information into module 200, such as a keyboard, a keypad, a mouse, a pen, a microphone, a remote control, a touch-screen display, one or more biometric mechanisms, or the like. Output device 240 may include a device that outputs information to the user, such as a display, a printer, a speaker, etc. Output device 240 may include a vibrator to alert a user.

Input device 230 and output device 240 may allow the user of module 200 to receive or view a menu of options. The menu may allow the user to select various functions or services associated with applications executed by module 200 or other devices coupled to network 102. Input device 230 and output device 240 may allow the user to activate a particular service or application, such as a service defined by a device table described below.

Communication interface 250 may include any transceiver-like mechanism that enables module 200 to communicate with other devices and/or systems. Communication interface 250 may include a transmitter that may convert baseband signals from processing logic 220 to radio frequency (RF) signals and/or a receiver that may convert RF signals to baseband signals. Alternatively, communication interface 250 may include a transceiver to perform functions of both a transmitter and a receiver. Communication interface 250 may be coupled to an antenna for transmission and reception of the RF signals. Communications interface 250 may include a network interface card, e.g., Ethernet card, for wired communications or a wireless network interface (WiFi) card for wireless communications. Communication interface 250 may also include, for example, a universal serial bus (USB) port for communications over a cable, a Bluetooth wireless interface for communicating with other Bluetooth devices, a near-field communication (NFC) device, etc. Communications interface 250 may receive, transmit and/or process digital or analog audio inputs/outputs and/or digital or analog video inputs/outputs.

Memory 260 may include a random access memory (RAM) or another type of dynamic storage device that may store information and instructions, e.g., an application, for execution by processing logic 220; a read-only memory (ROM) device or another type of static storage device that may store static information and instructions for use by processing logic 220; and/or some other type of magnetic or optical recording medium and its corresponding drive, e.g., a hard disk drive (HDD), for storing information and/or instructions.

Module 200 may perform certain operations, as described in detail below. Module 200 may perform these operations in response to processing logic 220 executing software instructions contained in a computer-readable medium, such as memory 260. A computer-readable medium may be defined as a physical or logical memory device. The software instructions may be read into memory 260 from another computer-readable medium or from another device via communication interface 250. The software instructions contained in memory 260 may cause processing logic 220 to perform processes that are described below.

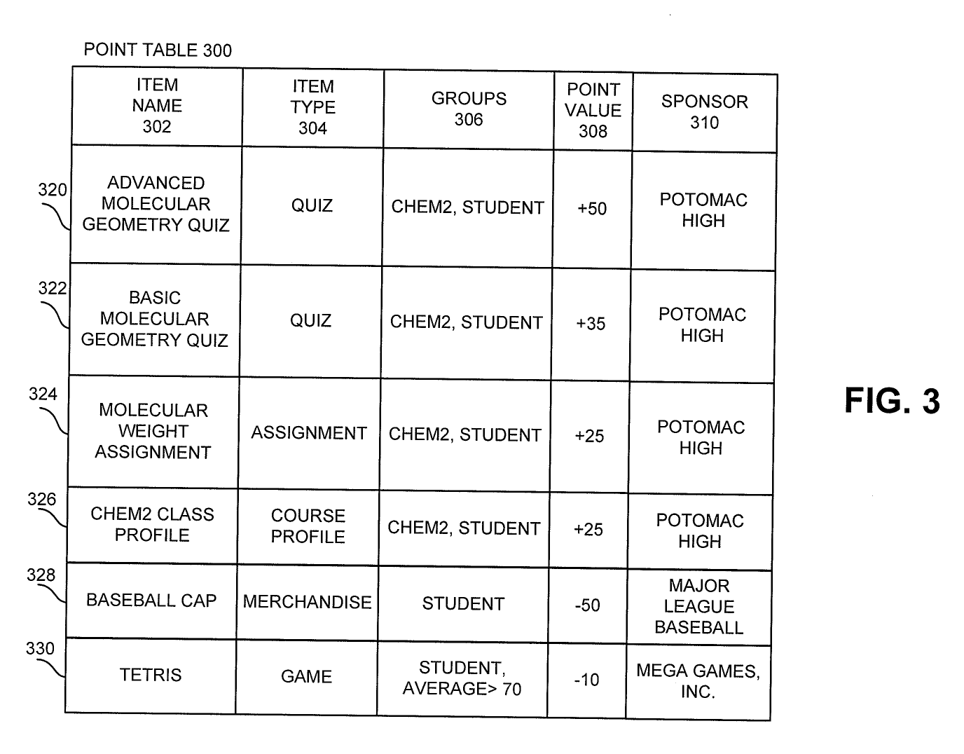

FIG. 3 is a block diagram of an exemplary point table 300. Point table 300 may store a point value associated with items. Items may include course profiles, assignment, or quizzes, for example, created by teachers. Assignments may include homework assignments, classroom assignments, take-home quizzes or tests (including a single or multiple questions), classroom quizzes or tests (including a single or multiple questions), etc. Items may also include merchandise or activities that a student may purchase with earned points from completing the course profiles, assignments, or quizzes, for example. Point table 300 may be stored in memory 260 of database 118, for example, or any device coupled to network 102. In another embodiment, point table 300 may be stored in memory 260 of profile database 124 or in memory 260 of materials database 126, for example. Point table 300 may include an item name field 302, an item type field 304, a groups field 306, a point value field 308, and a sponsor field 310. These fields are exemplary and point table 300 may include additional, different, or fewer fields than illustrated in FIG. 3. A number of records (e.g., records 320-33-) may include values for some or all of fields 302-310.

Item name field 302 may include the name of the document (e.g., course profile, quiz, or assignment) created by a teacher, for example. The name may be descriptive of the document, such as ADVANCED MOLECULAR GEOMETRY QUIZ as shown in record 320 of FIG. 3. Document names other than what is shown in FIG. 3 are possible. Item name field 302 may also include the name of merchandise that a student may purchase with earned points. The name may be descriptive of the document, such as BASEBALL CAP as shown in record 326. Item name field 302 may also include the name of an activity that a student may engage in (e.g., purchase) with earned points. The name may be descriptive of the event, such as TETRIS (e.g., the game of Tetris), as shown in record 328.

Item type field 304 may include the type of document associated with the record, such as QUIZ, ASSIGNMENT, COURSE PROFILE, MERCHANDISE, or GAME, for example. Item types other than what is shown in FIG. 3 are possible. As shown in record 320, the document with the name MOECULE GEOMETRY QUIZ may have the type QUIZ shown in item type field 304. As shown in record 322, the document with the name BASIC MOECULAR GEOMETRY QUIZ may also have the type QUIZ shown in type field 304. As shown in record 324, the document with the name MOLECULAR WEIGHT ASSIGNMENT may have the type ASSIGNMENT. As shown in record 326, the document with the name CHEM2 CLASS PROFILE may have the document type of COURSE PROFILE. As shown in record 328, the item with the name BASEBALL CAP may have a type name of MERCHANDISE. As shown in record 330, the item with the name TETRIS may have the type name of GAME.

Groups field 306 may include the groups of people allowed to access the document. For example, the document associated with record 320 may be accessed by CHEM2, STUDENT (e.g., a student taking Chemistry 2 class). Other exemplary groups may include CHEM2, PARENT (e.g., a parent of a student taking Chemistry 2 class), and ADMIN (e.g., any school or district administrator). Group types may also be expressed by an equation and may be conditional. For example, the item with the name TETRIS may be available to students (e.g., group STUDENT) with an average greater than 70%. A group defined in field 306 may be very general (e.g., STUDENT) or very specific (e.g., BRANDON LEE). In one embodiment, an item may be limited to a single individual who has achieved a particular achievement level in a specific class (e.g., BRANDON LEE, CHEM2 AVERAGE >90).

Point value field 308 may include a number of points associated with the particular quiz or assignment. For example, completing MOLECULAR WEIGHT ASSIGNMET may be given a point value of 25 points by the teacher who created that particular assignment. Completing BASIC MOLECULAR GEOMETYR QUIZ may be given a point value of 35 points by the teacher who created that particular quiz. Completing ADVANCED MOLECULAR GEOMETRY QUIZ may be given a point value of 50 points by the teacher who created that particular quiz. Completing the CHEM2 CLASS PROFILE may be given 25 points by the teacher who created that particular class profile. As also shown in exemplary point table 300, the item with the name BASEBALL CAP may be associated with negative 50 points and the item with the name TETRIS may be associated with a negative 10 points.

Other types of point values are possible for point table 300. For example, the point value could be broken down to particular questions, such as Q1=5, Q2=5, and Q3=5, indicating that a correct answer for the first question may be worth five points, a correct answer for the second question may be worth five point, etc. Formulas for points could be based on the date of completion, giving students an incentive to complete assignments early.

Sponsor field 310 may list the identity of the individual or institution that is providing the corresponding item listed in item name field 302. For example, the item BASEBALL CAP may be donated by Major League Baseball™. The item TETRIS may be donated by MEGA GAMES, INC. Using sponsor field 310, interactive environment 100 may allow for business (e.g., national or local businesses) to donate goods to schools and be recognized (e.g., as a form of advertisement). Parents may also donate merchandise to their children to encourage learning and achievement. In this example, the sponsor name listed in sponsor field 310 may be PARENT.

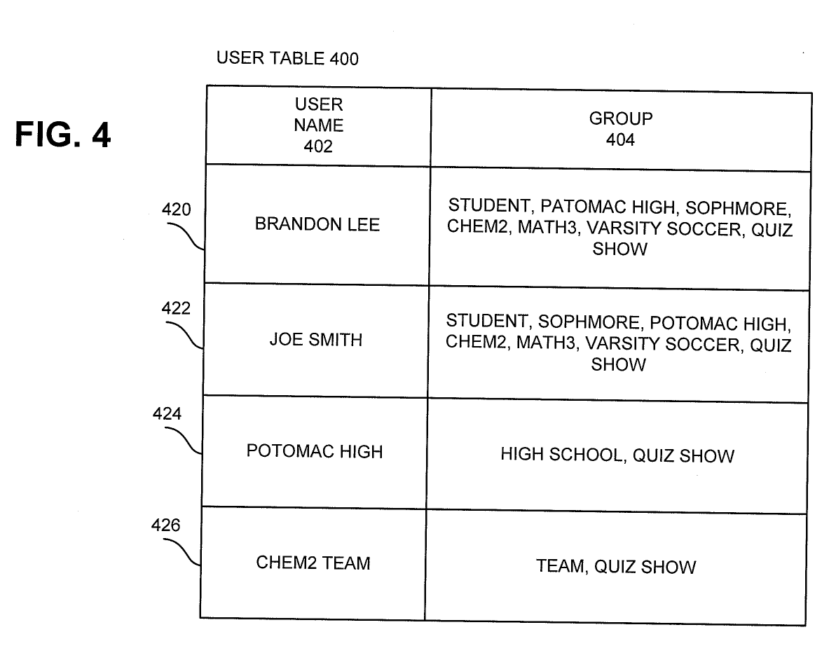

FIG. 4 is a block diagram of an exemplary user table 400. User table 400, e.g., a database, may store a list of users (including institutional users) that are allowed to access interactive environment 100, such as databases 118, 124, and 126, and application and web server 120, for example, and the groups associated with the corresponding user. User table 400 may be stored in memory 260 of any device attached to network 102, such as database 118, 124, or 126, or web server 120. User table 400 may include a user name field 402 and a group field 404. User table 400 may include additional, different, or fewer fields than illustrated in FIG. 4.

User name field 402 may include the name of a user or an institution that may have access to interactive environment 100. Students, teachers, parents, teams, and schools may each have a user name and a record in user table 400. In the exemplary user table 400, there are four users listed: BRANDON LEE, JOE SMITH, POTOMAC HIGH, and CHEM2 TEAM. In other words, Brandon Lee, Joe Smith, the Potomac High School, and the Chemistry 2 team may be allowed some form of access to interactive environment 100.

Group field 404 may indicate the groups with which the corresponding user name in user name field 402 is associated. In the exemplary user table 400, record 420 indicates the user name BRANDON LEE may be associated with the following groups as indicated in the corresponding group field 404: STUDENT, POTOMAC HIGH, SOPHOMORE, CHEM2, MATH3, VARSITY SOCCER, and QUIZ SHOW. In other words, Brandon Lee may be a sophomore student at Potomac High who takes Chemistry 2 and Math 3 classes, is on the varsity soccer team, and may participate in quiz shows. In the exemplary user table 400, record 422 indicates the user name JOE SMITH may be associated with the following groups as indicated in the corresponding group field 404: STUDENT, POTOMAC HIGH, SOPHOMORE, CHEM2, MATH3, VARSITY SOCCER, and QUIZ SHOW. In other words, Joe Smith may be a sophomore student at Potomac High who takes Chemistry 2 and Math 3 classes, is on the varsity soccer team, and may participate in quiz shows. Record 424 indicates the user name POTOMAC HIGH may be associated with the following groups: HIGH SCHOOL and QUIZ SHOW. In other words, Potomac High may be a high school that may participate in a quiz show, for example. Record 426 indicates the user name CHEM2 TEAM may be associated with the following groups: TEAM and QUIZ SHOW. In other words, the Chemistry 2 team may be a team that may participate in a quiz show as a team, for example.

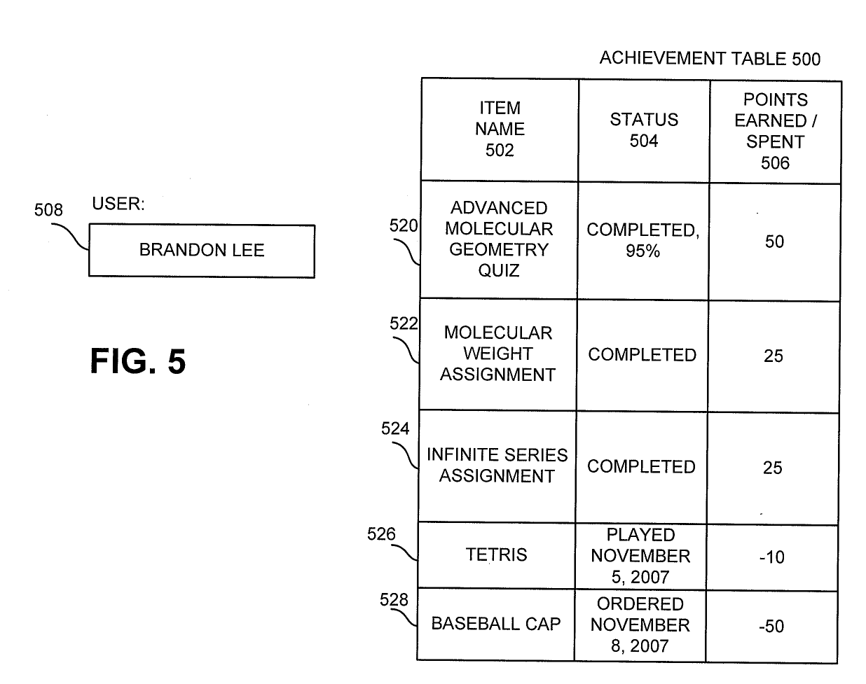

FIG. 5 is a block diagram of an exemplary achievement table 500. Achievement table 500, e.g., a database, may store the quizzes, and assignments completed by a user (e.g., a student, team, school, etc.), the corresponding grades for the quizzes or assignments, and the corresponding earned points. Achievement table 500 may also store the merchandise bought and activities completed by the student (or team, school, etc.) and the corresponding spent points. Each student, team, and school listed in user table 400 may be associated with its own achievement table. Achievement table 500 may be stored in memory 260 of profile database 124. In another embodiment, achievement table 500 may be stored in any device attached to network 102, such as in memory 260 of web server 120 or database 118. Achievement table 500 may include an item name field 502, a status field 504, a points earned/spent field 506, and a user field 508. Achievement table 500 may include additional, different, or fewer fields than illustrated in FIG. 5.

Item name field 502 may include the name of the quiz, assignment, activity, merchandise, etc., associated with the student (or team, school, etc.) listed in user field 508. Exemplary achievement table 500 may be for the student BRANDON LEE as indicated in user field 508. As indicated by item name field 502, user BRANDON LEE may have taken the following quizzes and assignments: ADVANCED MOLECULAR GEOMETRY QUIZ, MOLECULAR WEIGHT ASSIGNMENT, and INFINITE SERIES ASSIGNMENT. As also indicated item name field 502, user BRANDON LEE may also have played TETRIS and bought a BASEBALL CAP.

Status field 504 may indicate the status of the corresponding item listed in item name field 502. For example, as indicated in status field 504, user BRANDON LEE completed the ADVANCED MOLECULAR QUIZ (and received a 95% score), the MOLECULAR WEIGHT ASSIGNMENT, and the INFINITE SERIES ASSIGNMENT. As indicated in status field 504, user BRANDON LEE played TETRIS on Nov. 5, 2007, and ordered a BASEBALL CAP on Nov. 8, 2007.

Points earned/spent field 506 may indicate the number of points earned or spent for the corresponding item in item name field 502. For example, user BRANDON LEE earned 50 points for completing the ADVANCED MOLECULAR GEOMETRY QUIZ, 25 points for completing the MOLECULAR WEIGHT ASSIGNMENT, and 25 points for completing the INFINITE SERIES ASSIGNMENT. Points earned completing assignments may correspond to the point value in point value field 308 of point table 300. On the other hand, user BRANDON LEE also spent 10 points playing TETRIS and spent 50 points by purchasing a BASEBALL CAP.

Points earned and spent (as indicated in field 506) may also be calculated based on a formula as indicated in point value field 308. For example, since user BRANDON LEE did not achieve a 100% score on the ADVANCED MOLECULAR GEOMETRY QUIZ, and, in one embodiment, he may receive less than 50 points depending on the point equation in point value field 308.

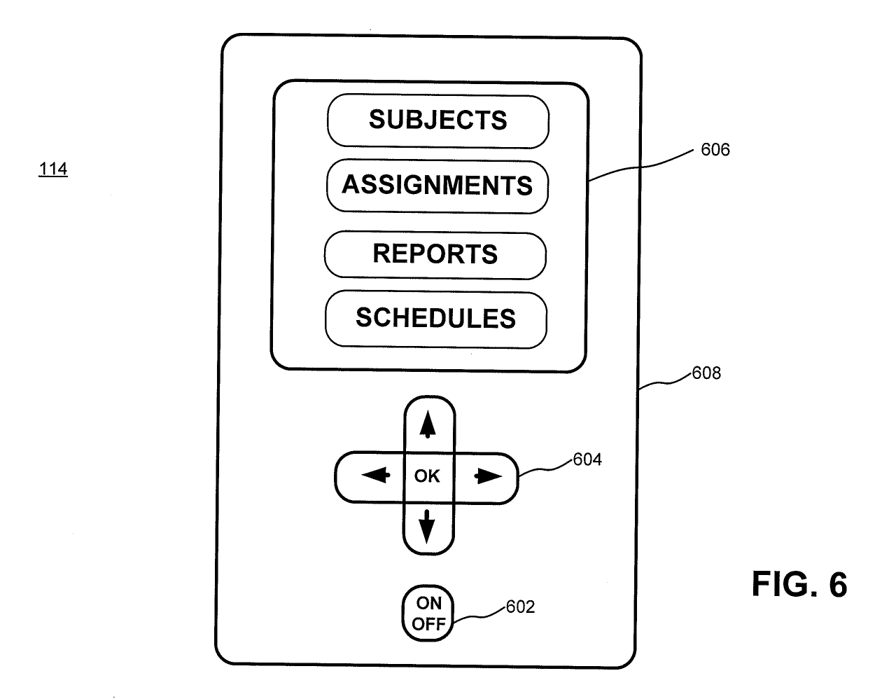

FIG. 6 is a diagram of an exemplary remote 114 of FIG. 1. Remote 114 may include an on/off button 602, control buttons 604, a display 606, and a housing 608. On/off button 602 may turn TV 110 on and off. Control buttons 604 may include left, right, up, down, and OK buttons. The user of remote 114 may interact with TV 110 to control TV 110. For example, remote control 114 may be used to navigate menus displayed on TV 110. Remote 114 may also be used to navigate menus displayed on display 606, such as navigating and selecting a SUBJECTS button, an ASSIGNMENTS button, a REPORTS button, and a SCHEDULES button. Remote control 114 may be used, for example, to input answers to quiz questions shown on TV 110 or display 606. Remote 114 may communicate with TV 110 via infra red (IR) or RF signals.

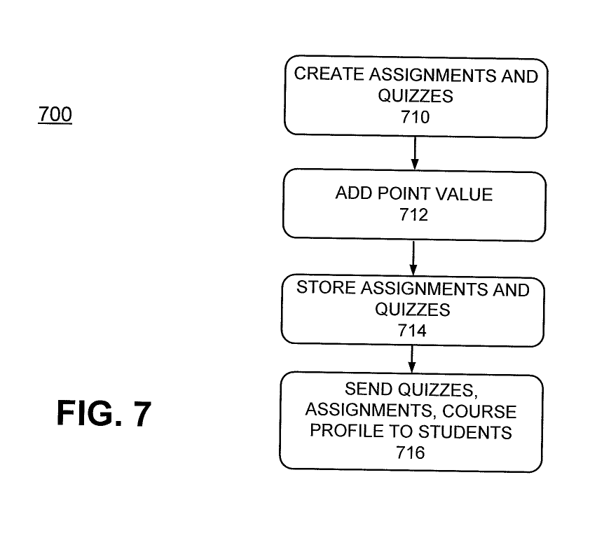

FIG. 7 is a flowchart of an exemplary process 700 for creating assignments and quizzes and associating point values to assignments and quizzes. An assignment or quiz may be created (block 710). For example, the teacher, using classroom computer 104, may create an assignment or quiz for students to complete at home. The teacher may also create a quiz or assignment for students to complete at home or in the classroom. Content may be added to the assignment or quiz from materials database 126. The teacher may search and browse content from materials database 126 from classroom computer 104, for example, to determine what material may be best for inclusion in the quiz or assignment. A point value may be added (block 712). The teacher may determine the point value to associate with the quiz or assignment. For example, the teacher may determine that the ADVANCED MOLECULAR GEOMETRY QUIZ of record 320 in point table 300 may be valued at 50 points. Accordingly, the teacher may record 50 points in point table 300. The assignment or quiz may be stored (block 714). The teacher may store the assignment or quiz in database 118. For example, a teacher may create the ADVANCED MOLECULAR GEOMETRY QUIZ and save it to database 118 in record 320 of point table 300.

Assignments, quizzes, and course profiles may be sent to or associated with students (block 716). In one embodiment, the teacher may use classroom computer 104 to email course profiles, assignments, and/or quizzes to students or associate course profiles, quizzes, or assignments with users' profiles. Teachers may send assignments, quizzes, and course profiles to an entire class, to groups within a class, or to individuals, e.g., individuals in need of special attention.

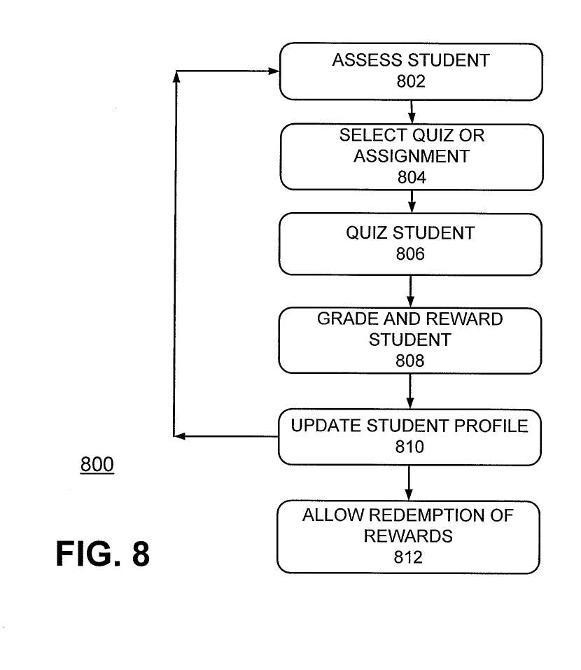

FIG. 8 is a flowchart of an exemplary process 800 for testing students. Process 800 may run in application server 120, for example. In another embodiment, the execution of process 800 may be distributed among various devices in environment 100. Process 800 may begin with a student being assessed (block 802). An assessment may include determining the groups associated with a student (e.g., group field 404 in user table 400) and which quizzes match a student's group (e.g., groups field 306 in point table 300). An assessment may be initiated automatically by interactive environment 100 or may be requested by the student. One of the assignments, quizzes, and/or course profiles found in block 802 may be selected (block 804). The student may select the assignment, quizzes, and/or course profile to complete or interactive environment 100 may select the assignment or quiz automatically.

The student may be quizzed (block 806). Quizzes, assignment, etc., may be retrieved from database 118. The student may be given an assignment or a quiz based on the assessment of the student in block 802. Process 800 may access information stored in profile database 124 and/or course curriculum, course profile, and assignment database 118. Quizzes and assignments may include different types of media, including PDFs, interactive content, and video. The student may use student computer 104 or TV 110 to download the assignments, quizzes, and other materials. The student may complete the quizzes and assignments on computer 104 or TV 110 and may send the completed quizzes to his or her teacher. In one embodiment, the quizzes and assignments are interactive, online interactive quizzes which are objective and may be scored by the system.

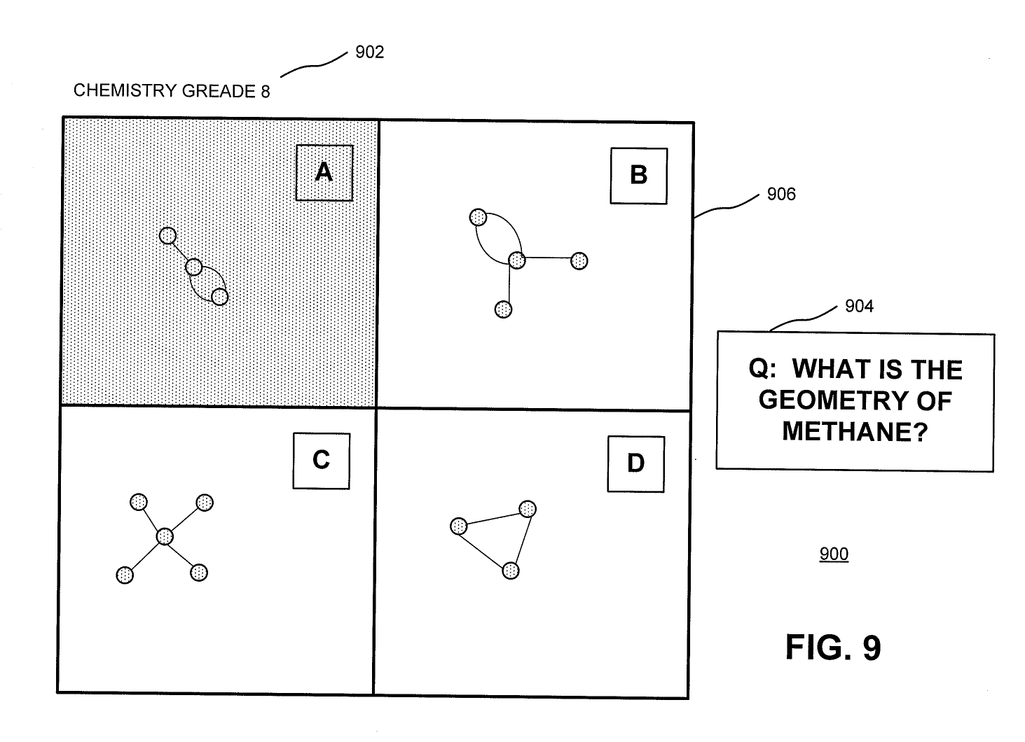

FIG. 9 is a block diagram of an exemplary graphical user interface (GUI) 900 for displaying an exemplary quiz question. GUI 900 may include a quiz title 902, a question 904, and a multiple choice selection 906 including A, B, C, and D. The student may use control keys 604 on remote 114 to navigate to what he or she believes to be the correct answer and may select the answer by pressing the OK button. GUI 900 may be shown on display 606 of remote 114, for example, or on TV 110. A quiz or assignment may include a series of questions, such as the question on exemplary GUI 900. In one embodiment, the assignment or quiz may be informational in nature, e.g., study material, support information, or support material.

Returning to FIG. 8, the student may be scored and rewarded (block 808). For example, the quiz or assignment given to the student in block 806 may be scored, e.g., graded, and points earned may be determined. In one embodiment, assignments and quizzes may be scored automatically, which may provide the teacher and parent immediate feedback on student performance. Automatic scoring may also allow the student the immediate gratification of receiving earned points for redemption. In an embodiment where the assignment or quiz is informational in nature, e.g., study material, support information, or support material, the scoring may simply include generating an indication that the student reviewed the material.

The student's profile may be updated (block 810). The student's profile on profile database 124 may be updated to take into account the score achieved on the assignment in block 806 and the points earned, if any. For example, if Brandon Lee scored 95% on the ADVANCED MOLECULAR GEOMETRY QUIZ, then achievement table 500 may be updated to include this information (e.g., the information in record 520). Updating the student's profile may include rewarding the student for having completed the quiz or assignment. For example, Brandon Lee's profile may include 50 points earned for completing the ADVANCED MOLECULAR GEOMETRY QUIZ, as indicated in record 520 of achievement table 500.

The student may be allowed to redeem the awards (block 812). Points may be accumulated by the student over a period of time, for example, and the number of points may be stored in the student's profile in an achievement table, such as achievement table 500. For example, a student may be able to play a game or buy merchandise when a certain number of points have been accumulated. When redeeming points, points may be subtracted from the achievement table associated with the student, such as achievement table 500. The number of points subtracted may be based on a value of merchandise provided to the student. The number of points for subtraction may be stored in point table 300. For example, achievement table 500 indicates that Brandon Lee redeemed 10 points (as stored in record 328 of point table 300) by playing TETRIS on Nov. 5, 2007. Achievement table 500 also indicates that Brandon Lee redeemed 50 points (as stored in record 326 of point table 300) by ordering a baseball cap on Nov. 8, 2007.

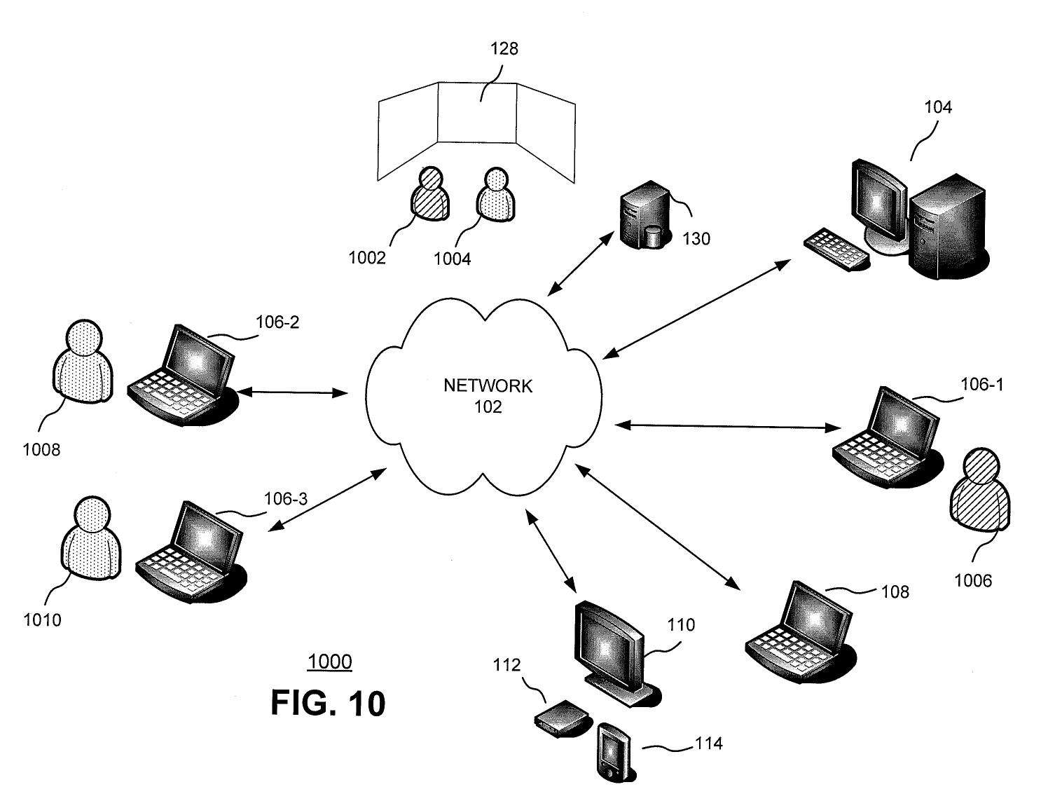

FIG. 10 is a block diagram of an environment 1000 for providing an exemplary interactive quiz show. Environment 1000 may include network 102, studio 128, studio server 130, TV 110, STB 112, remote 114, and student computers 106-1 through 106-3. One or more of student computers 106-1 through 106-3 may be configured similarly to student computer 106 described above. In another embodiment, one or more of student computers 106-1 through 106-3 may be configured similarly to TV 110. In this latter embodiment, one or more of student computers 106-1 through 106-3 may include remote controls and set top boxes similar to remote 114 and STB 118. In this embodiment, quiz questions may be shown on the TV (similar to TV 110) or on the display of the remote control (similar to display 606 of remote 114).

The exemplary interactive quiz show of FIG. 10 may include five students, e.g., contestants: two live students 1002 and 1004 physically present in studio 128 and three students 1006, 1008, and 1010 participating remotely from student computers 106-1, 106-2, and 106-3, respectively. In one embodiment, students may be associated with different teams. For example, students 1002 and 1006 may attend the same school and may both be associated with a team for the school they both attend. As shown in FIG. 10, students 1002 and 1006 are striped. Contestants 1004, 1008, and 1010 may all attend the same school (but different than contestants 1002 and 1006) and may be associated with a team for the school they attend. As shown in FIG. 10, students 1004, 1008, and 1010 are dotted.

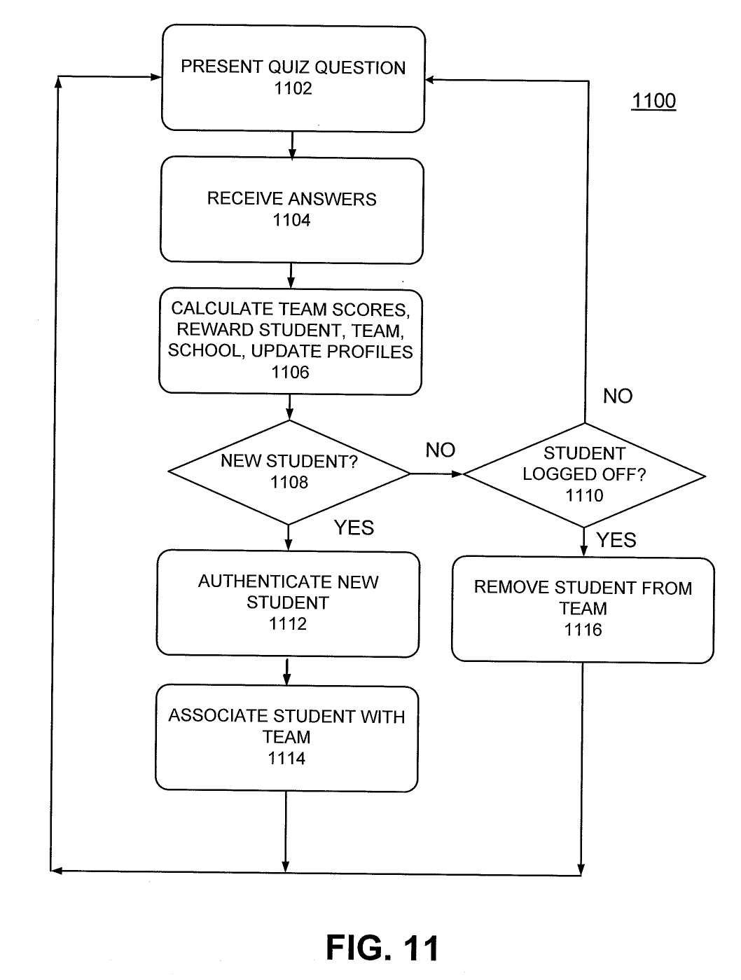

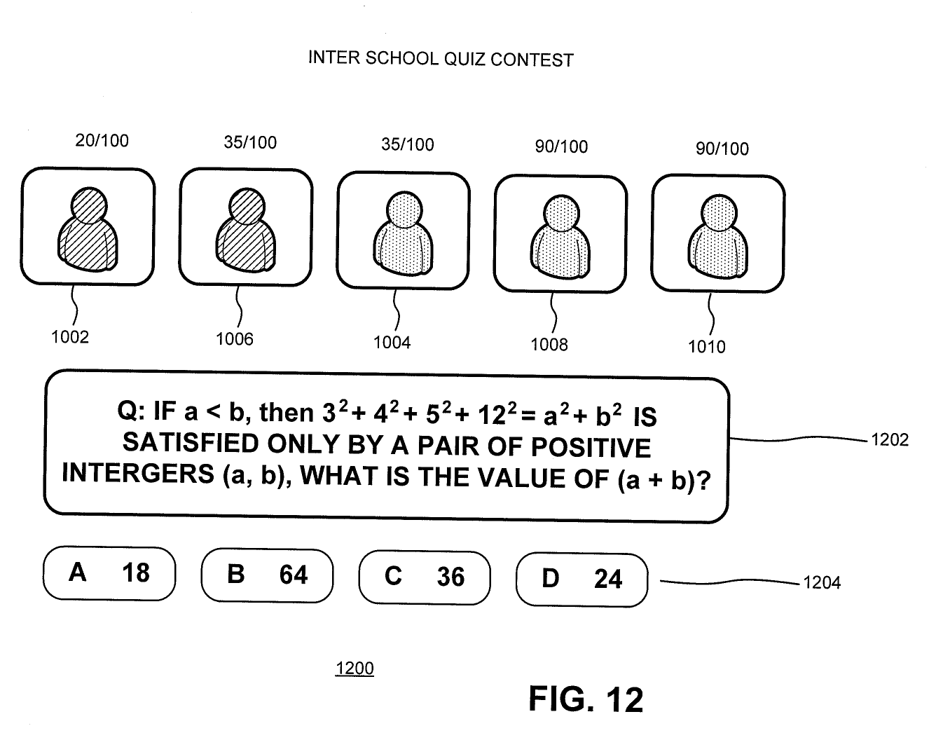

FIG. 11 is a flowchart of an exemplary process 1100 for an interactive quiz game show of FIG. 10. Processing may begin upon presentation of a quiz question to the student contestants (block 1102). FIG. 12 is a block diagram of a GUI 1200 for displaying the exemplary interactive quiz show. GUI 1200 may be shown on TV 110, for example, for viewing by parents, teachers, other students, or the public. GUI 1200 may also be shown on student computers 106-1 through 106-3, for example, for students 1006, 1008, and 1010 to interact with during the live quiz show. GUI 1200 may include pictures or live images of students 1002 through 1010. GUI 1200 may include a question 1202 and multiple choice answers 1204.

Answers may be received (block 1104). For example, student 1006 may use control keys (similar to control keys 604) on a remote control (similar to remote 114) to navigate to what he or she believes to be the correct answer and may select the answer by pressing the OK button. Answers may also be received from students 1008 and 1010 through a keyboard or microphone, for example.

The accuracy of the answers and the team score may be determined and students, teams, and/or schools may be rewarded and profiles may be updated (block 1106). For example, a contestant may receive a point for every correct answer. In another embodiment, the team may receive a point for every correct answer by a team member. In yet another embodiment, the school may receive a point for every correct answer by a school member. In one embodiment, point table 300 may store quiz questions and point values associated with each quiz question. In this embodiment, students, teams, and/or schools may be rewarded the point value stored in point table 300. Profiles may be updated to reflect points earned answer correct quiz questions. In one embodiment, the team and/or the school may be associated with an achievement table that may be updated to reflect earned points.

The interactive quiz show may allow for students to join or leave the show (block 1108). If no new student wishes to join the quiz show (block 1108: NO) and no student logs off the quiz show (block 1110: NO), then process 1100 may return to block 1102 for a new question. If a new student wishes to join the quiz show (block 1108: YES), he or she may be authenticated (block 1112) and associated with a team for the quiz session (block 1114), and process 1100 may then continue with an additional quiz question being presented (block 1102). If a student has logged off (block 1110: YES), then the student may be removed from the appropriate team for the quiz session (block 1114). Processing may then return to block 1102 for presentation of the next question to the remaining team members or participants.

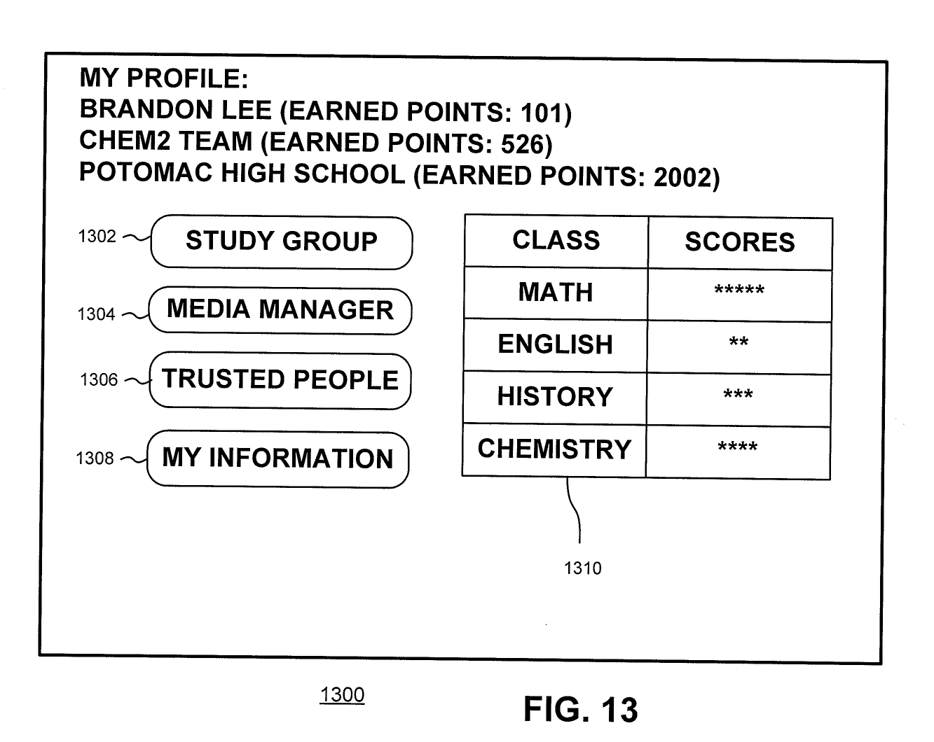

FIG. 13 is a block diagram of a GUI 1300 associated with an exemplary student profile. As illustrated in FIG. 13, exemplary GUI 1300 may be associated with a student named Brandon Lee of Potomac High School. GUI 1300 may include a STUDY GROUP option 1302, a MEDIA MANAGER option 1304, a TRUSTED PEOPLE option 1306, and a MY INFORMATION option 1308. A student may select MY INFORMATION option 1308 to access test scores, assignments due, assignment scores, grades, etc. A student may select STUDY GROUP option 1303 to communicate with those and define those other students for interaction. A student may select MEDIA MANAGER option 1304 to view movies, recorded classes, and television shows, and to listen to music, etc. A student may select TRUSTED PEOPLE option 1306 to define individuals that may access the student's information, such as parents, siblings, teachers, and other students. GUI 1300 may also include a brief display 1310 of the student's scores. GUI 1300 may also include the number of points accumulated by the student (for completing assignments and quizzes, for example) for later redemption. GUI 1300 may also include the number of points accumulated by the school (e.g., for quiz shows) for later redemption. As shown in FIG. 13, Brandon Lee has accumulated 101 points for redemption, the CHEM2 TEAM earned 526 points for redemption, and POTOMAC HIGH earned 2002 points for redemption.

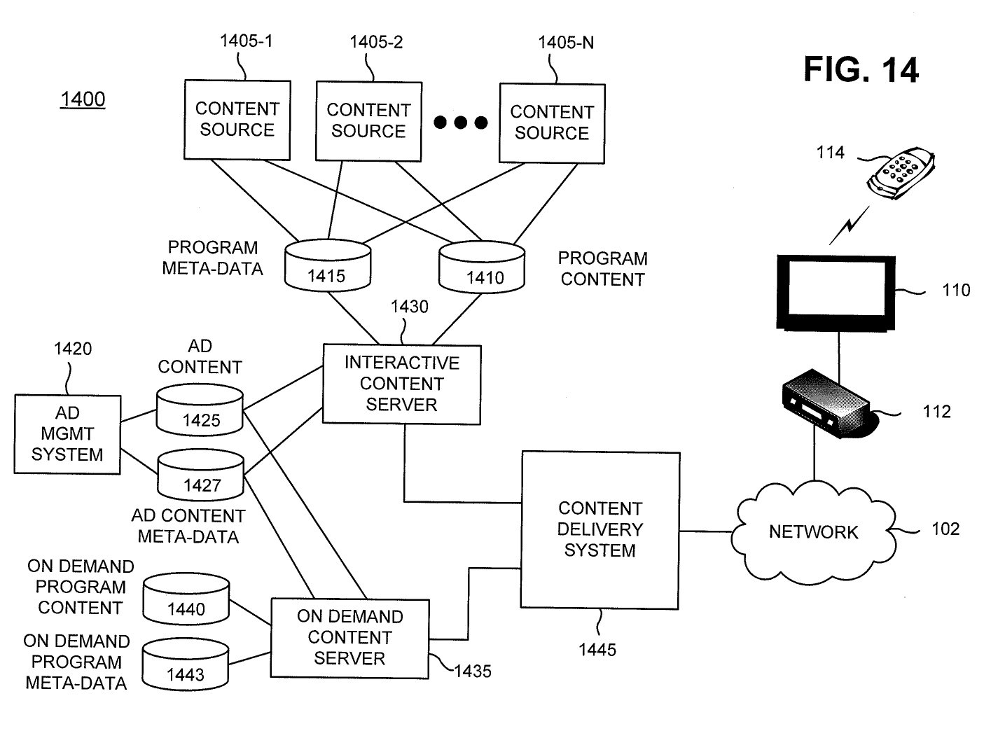

FIG. 14 is a block diagram of an alternative exemplary environment 1400 in which systems and methods described herein may be implemented. Environment 1400 may include content sources 1405-1, 1405-2, . . . , 1405-N (where N>=1) (collectively referred to as “content sources 1405”), a program content database 1410, a program meta-data database 1415, an advertising (ad) management (mgmt) system 1420, an advertising content database 1425, an advertising content meta-data database 1427, an interactive content server 1430, an on-demand content server 1435, an on-demand content database 1440, an on-demand meta-data database 1443, and a content delivery system 1445. Environment 1400 may also include network 102, STB 112, TV 110, and remote control 114 as shown in FIG. 1. In practice, environment 1400 may include more, fewer, or different devices than are shown in FIG. 14. Also, two or more of these devices may be implemented within a single device, or a single device may be implemented as multiple, distributed devices. Further, while FIG. 14 shows direct connections between the various devices, any of these connections can be indirectly made via a network, such as a local area network, a wide area network (e.g., the Internet), a telephone network (e.g., the Public Switched Telephone Network (PSTN) or a cellular network), or a combination of networks.

Content sources 1405 may include any type or form of content, including interactive or non-interactive content. For example, content sources 1405 may include free television broadcasts (e.g., local broadcasts, such as NBC, CBS, ABC, and Fox), for-pay television broadcasts (e.g., TNT, ESPN, HBO, Cinemax, CNN, etc.), and/or web-based content (e.g., streaming content from web sites). For example, content sources 1405 may include one or more studios and studio servers, such as studio 128 and studio server 130 of FIG. 1. Content sources 1405 may include one or more materials databases, such as materials database 126 of FIG. 1. Content sources 1405 may include one or more quiz databases, such as assignment database 118 of FIG. 1. Content sources 1405 may include one or more student profile databases, such as student profile database 124 of FIG. 1.

Program content database 1410 may store video signals representing the programs provided by various ones of content sources 1405. Program content database 1410 may store interactive or non-interactive content.

Program meta-data database 1415 may store meta-data associated with the programs provided by various ones of content sources 1405. Program meta-data database 1415 may store an association between content and advertisements with which the content corresponds. In one embodiment, program meta-data database 1415 may also store content icons and an association between the content icons and the programs and/or advertisements with which the content icons correspond. The meta-data might include program descriptions, program line-ups and/or schedules, or other information associated with the programs in program content database 1410. An example of meta-data may include information stored in point table 300, e.g., in an XML (eXtensible Markup Language)-based data file.

Advertising management system 1420 may control advertising content presented in connection with the programs in program content database 1410 and/or on-demand content database 1440. Advertising management system 1420 may store advertising content in advertising content database 1425. The advertising content may include advertisements (e.g., commercials that are inserted within a program signal, long form advertisements that are not inserted within the program signal, text or graphics that are overlaid on a program or an advertisement, advertisements that are presented alongside the program signal, and/or interactive advertisements) and/or links to advertisements that may be served via a network, such as the Internet. Advertising content meta-data database 1427 may store meta-data associated with the advertisements in advertising content database 1425. Meta-data stored in database 1427 may include, for example, scheduling information, rating information, category information, length of advertisement, classification information, expiration date of the advertisement, or other information that advertising management system 1420 and/or content servers 1430 and/or 1435 may find useful in serving and/or targeting the advertising content.

Interactive content server 1430 may include a device that is capable of controlling the serving of programs from program content database 1410, the program meta-data from program meta-data database 1415, and/or the advertising content from advertising content database 1425. Interactive content server 1430 may also serve non-interactive content from non-interactive content sources. In one embodiment, content server 1430 may include a content mixing engine to select information, such as programs, program meta-data, advertising content, and/or advertisement meta-data, and mix the information together. Interactive content server 1430 may also perform transcoding of the mixed information. Interactive content server 1430 may include a device that is capable of managing the serving of interactive content, such as live, interactive learning content. Interactive content server 1430 may retrieve content, as necessary, from program content database 1410.

On-demand program database 1440 may store on demand content. For example, previously recorded live, interactive learning content may become on-demand content after a showing and may be stored in on-demand program content database 1440. In one embodiment, on-demand program database 1440 may include one or more materials databases, such as materials database 126 of FIG. 1. On-demand program database 1440 may include one or more quiz databases, such as assignment database 118 of FIG. 1. On-demand program database 1440 may include one or more student profile databases, such as student profile database 124 of FIG. 1.

On-demand meta-data database 1443 may store meta-data associated with the programs stored in on-demand program database 1440. On-demand program meta-data database 1443 may store an association between content and advertisements with which the content corresponds. In one embodiment, on-demand program meta-data database 1443 may also store content icons and an association between the content icons and the programs and/or advertisements with which the content icons correspond. The meta-data might include program descriptions, program line-ups and/or schedules, or other information associated with the programs in on-demand program content database 1440. An example of meta-data may include information stored in point table 300, e.g., in an XML-based data file.

On-demand content server 1435 may retrieve on-demand content, as necessary, from on-demand content database 1440. On-demand content server 1435 may include a device that is capable of controlling the serving of programs from on-demand program content database 1440, meta-data from on-demand meta-data database 1443, meta-data from ad content meta-data database 1427, and/or advertising content from advertising content database 1425. In one embodiment, content server 1430 may include a content mixing engine to select information, such as programs, program meta-data, advertising content, and/or advertisement meta-data, and mix the information together. Content server 1435 may also perform transcoding of the mixed information.

Content delivery system 1445 may include a device that is capable of delivering information to a customer's equipment (e.g., STB 112, TV 110, etc.). Content delivery system 1445 may include a service adapter component and a media relay component. The service adapter component may control what information (e.g., what programs and/or advertisements) to provide to which customers based, for example, on customer subscriptions and/or profiles, groups, etc. (e.g., user table 400, achievement table 500, and/or point table 300). The media relay component may control the transmission of the information to the customers. The media relay component may perform encoding and/or encryption functions. Content delivery system 1445 may also include one or more on demand components that may provide on demand services (e.g., music, video, and/or games on demand).

This patent application hereby incorporates herein by reference the following patent applications, filed on the same day as the present application: (1) INTERACTIVE LEARNING, Attorney Docket No. 20070262; (2) INTERACTIVE LEARNING, Attorney Docket No. 20070261; and (3) INTERACTIVE LEARNING, Attorney Docket No. 20070213.

Interactive learning may be a better learning environment for students as compared to passive television viewing. In one or more embodiments described above, students may communicate and collaborate with their teachers, peers, and parents in a learning environment. One or more embodiments disclosed above may allow for management of the learning work flow; assessment of student achievement; ad hoc communication and collaboration among educators, students, and parents; and sharing and management of educational content. A high-speed, symmetric, fiber-optic network may provide for some or all of the structure to implement systems and methods described herein.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above, such as in FIGS. 7, 8, and 11, the order of the blocks may differ in other implementations. Moreover, non-dependent acts may be performed in parallel.

It will be apparent that aspects of the embodiments, as described above, may be implemented in many different forms of software, firmware, and hardware in the implementations illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to the embodiments based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
identifying, by a computer, academic class names stored in a database and associated with a student;
selecting, by the computer, an assignment from a plurality of assignments based on the identified class names;
sending the selected assignment through a network to the student;
receiving, through the network, a completed assignment from the student; and
adding points, after receiving the completed assignment from the student, to an account associated with the student.

2. The method of claim 1, further comprising:
sending, through the network, a list of a plurality of items of merchandise or activities to the student;
receiving, through the network, a selection from the student of a selected item from the list; and
subtracting points from the account associated with the student, the number of points subtracted based on a value of the selected item.

3. The method of claim 1, further comprising:
scoring, by the computer, the completed assignment and recording the score in the database;
where adding points to the account associated with the student includes adding points based on the scoring by the computer.

4. The method of claim 2, further comprising:
identifying, by the computer, assignment scores stored in the database and associated with the student; and
where selecting the assignment includes selecting the assignment based on the identification of assignment scores.

5. The method of claim 1, further comprising:
associating each of the plurality of assignments with one of a plurality of academic class names; and
where selecting the assignment from the plurality of assignments includes comparing the identified class names with the plurality of academic class names.

6. The method of claim 2, further comprising:
associating each item of the plurality of items of merchandise or activities with a name of a sponsor; and
indicating to the student the name of the sponsor of the selected item.

7. The method of claim 1, further comprising:
associating each of the plurality of assignments with an expression indicating a point value for adding to the account of the student.

8. The method of claim 1, further comprising:
adding points, after receiving the completed assignment from the student, to an account associated with a team of students or a school associated with the student.

9. The method of claim 8, further comprising:
displaying the assignment on a display;
receiving answers to the assignment via a remote control associated with the display.

10. A system comprising:
a database to store:
student class names associated with a student; and
a plurality of assignments and a plurality of academic class names, where one of the plurality of academic class names is associated with each of the plurality of assignments;
a processor to:
identify the student class names associated with the student; and
select one of the plurality of assignments based on the identified student class names associated with the student and the plurality of academic class names associated with the plurality of assignments; and
a transceiver to send the selected one of the plurality of assignments through a network to the student and receive, through the network, a completed assignments from the student,
where the processor is further configured to add points, after receiving the completed assignment, to an account associated with the student.

11. The system of claim 10, where the transceiver sends a list of a plurality of items of merchandise or activities to the student and receives a selection from the student of a selected item from the list; and
where the processor subtracts points from the account associated with the student, the number of points subtracted based on a value of the selected item.

12. The system of claim 10, where the processor scores the completed assignment, records the score in the database, and adds points to the account associated with the student based on the score.

13. The system of claim 11, where the processor identifies assignment scores stored in the database and associated with the student, and selects the assignment based on the identification of assignment scores.

14. The system of claim 10, where the database includes information associating each of the plurality of assignments with one of a plurality of academic class names, and where the processor selects the assignment from the plurality of assignments by comparing the identified student class names with the plurality of academic class names.

15. The system of claim 11, where the database stores information associating each item of the plurality of items of merchandise or activities with a name of a sponsor; and the transceiver sends to the student the name of the sponsor of the selected item.

16. The system of claim 10, where the database associates each of the plurality of assignments with an expression indicating a point value for adding to the account of the student.

17. The system of claim 10, where the processor adds points to an account associated with a team of students or a school associated with the student.

18. The system of claim 17, further comprising:
a display to display the assignment; and
a remote control associated with the display, where the remote control is configured to receive answers to the assignment.

19. A computer-readable medium including instructions executable by at least one processor, the computer readable medium comprising:
one or more instructions for identifying academic class names stored in a database and associated with a team of students;
one or more instructions for selecting an assignment from a plurality of assignments based on the identified class names;
one or more instructions for sending the selected assignment through a network to the student;
one or more instructions for receiving, through the network, a completed assignment from one or more students of the team of student; and
one or more instructions for adding points, after receiving the completed assignment from the student, to an account associated with the team of students.

20. The method of claim 1, further comprising:
one or more instructions for sending, through the network, a list of a plurality of items of merchandise or activities to the team of students;
one or more instructions for receiving, through the network, a selection from the team of students of a selected item from the list; and
one or more instructions for subtracting points from the account associated with the student, the number of points subtracted based on a value of the selected item.
